(19) United States
(12) Patent Application Publication
(10) Pub. No.: US 2010/0106994 A1
(43) Pub. Date: Apr. 29, 2010

(54) METHOD, APPARATUS, AND SYSTEM FOR ADAPTING POWER CONSUMPTION

(76) Inventors: David Carroll Challener, Raleigh, NC (US); Harriss Christopher Neil Ganey, Cary, NC (US); Howard Locker, Cary, NC (US)

Correspondence Address: Kunzler Needham Massey & Thorpe, 8 EAST BROADWAY, SUITE 600, SALT LAKE CITY, UT, 84111, US

(21) Appl. No.: 12/259,074

(22) Filed: Oct. 27, 2008

(51) Int. Cl. G06F 1/26; G06F 9/46

(52) U.S. Cl. 713/330; 718/102

(57) ABSTRACT

A method, apparatus, and system are disclosed for adapting power consumption. A recording module records a usage record for each component within a computer at scheduled audit times. The usage record comprises a usage level, an application list, a time stamp, a network access point, a computation category, a time category, and a location category. A scenario module creates a plurality of usage scenarios. Each usage scenario comprises a unique combination of a specified computation category, a specified time category, and a specified location category. A profile module creates a power setting profile for each usage scenario. Each power setting profile specifies a target power status for each component of the computer. A scenario detection module detects a first usage scenario. An adjustment module sets a power status of each component to the first usage scenario target power status for the component.

### BACKGROUND OF THE INVENTION

1. Field of the Invention

This invention relates to power consumption and more particularly relates to adapting power consumption.

2. Description of the Related Art

An electronic device often supports managing power consumption for the device. A user may turn off some components and reduce the functionality of others to reduce power consumption.

Unfortunately, the user of the electronic device may be unaware of the power consumption settings. In addition, the user may never alter the power consumption settings after an initial setting.

### SUMMARY OF THE INVENTION

From the foregoing discussion, there is a need for a method, apparatus, and system that adapts power consumption. Beneficially, such a method, apparatus, and system would automatically adjust the power status of components.

The present invention has been developed in response to the present state of the art, and in particular, in response to the problems and needs in the art that have not yet been fully solved by currently available power consumption adjustment methods. Accordingly, the present invention has been developed to provide a method, apparatus, and system for adjusting power consumption that overcome many or all of the above-discussed shortcomings in the art.

A method of the present invention is presented for adjusting power consumption. In one embodiment, the method includes recording a usage record, creating a plurality of usage scenarios, creating a power setting profile, detecting a first usage scenario, and setting a power status.

A recording module records a usage record for each component within a computer at scheduled audit times. The usage record comprises a usage level, an application list, a time stamp, a network access point, a computation category, a time category, and a location category.

A scenario module creates a plurality of usage scenarios. Each usage scenario comprises a unique combination of a specified computation category, a specified time category, and a specified location category.

A profile module creates a power setting profile for each usage scenario. Each power setting profile specifies a target power status for each component of the computer. A scenario detection module detects a first usage scenario. An adjustment module sets a power status of each component to the first usage scenario target power status for the component.

The apparatus for adjusting power consumption is provided with a plurality of modules configured to functionally execute the steps of the method. The modules include the recording module, the scenario module, the profile module, the scenario detection module, and the adjustment module.

The recording module records a usage record for each component within an electronic device at scheduled audit times. The usage record comprises a usage level, an application list, a time stamp, a network access point, a computation category, a time category, and a location category.

The scenario module creates a plurality of usage scenarios. Each usage scenario comprises a unique combination of a specified computation category, a specified time category, and a specified location category.

The profile module creates a power setting profile for each usage scenario. Each power setting profile specifies a target power status for each component of the electronic device. A scenario detection module detects a first usage scenario. An adjustment module sets a power status of each component to the first usage scenario target power status for the component.

A system of the present invention is also presented to adjust power consumption. The system may be embodied in a computer. In particular, the system, in one embodiment, includes a plurality of components, a memory, and a processor.

Each component includes a power status. The memory stores computer readable programs. The processor executes the computer readable programs. The computer readable programs include the recording module, the scenario module, the profile module, the scenario detection module, the adjustment module, and a service detection module.

The recording module records a usage record for each component within the system at scheduled audit times. The usage record comprises a usage level, an application list, a time stamp, a network access point, a computation category, a time category, and a location category.

The scenario module creates a plurality of usage scenarios. Each usage scenario comprises a unique combination of a specified computation category, a specified time category, and a specified location category.

The profile module creates a power setting profile for each usage scenario. Each power setting profile specifies a target power status for each component of the system. The scenario detection module detects a first usage scenario. The adjustment module sets a power status of each component to the first usage scenario target power status for the component.

The service detection module may detect a service level violation for a first component. The adjustment module adjusts the power status for the first component to provide the specified service level.

References throughout this specification to features, advantages, or similar language do not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

The present invention adjusts power consumption by creating usage scenarios, creating power setting profiles for the usage scenarios, detecting a first usage scenario, and setting the power status for components to a target power status for the first usage scenario. These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective drawing illustrating one embodiment of a notebook computer in accordance with the present invention;

FIG. 2 is a front view drawing illustrating one embodiment of a mobile phone of the present invention;

FIG. 3 is a schematic block diagram illustrating one embodiment of a computer of the present invention;

FIG. 4 is a schematic block diagram illustrating one embodiment of a power consumption adaption apparatus of the present invention;

FIG. 5 is a schematic flow chart diagram illustrating one embodiment of a power consumption adaption method of the present invention;

FIG. 6 is a histogram illustrating a prophetic example of usage demand of a component of the present invention;

FIG. 7 is a schematic block diagram illustrating one embodiment of usage profiles of the present invention; and

FIG. 8 is a schematic block diagram illustrating one embodiment of usage records of the present invention.

### DETAILED DESCRIPTION OF THE INVENTION

Many of the functional units described in this specification have been labeled as modules, in order to more particularly emphasize their implementation independence. Modules may include hardware circuits such as one or more processors with memory, Very Large Scale Integration (VLSI) circuits, gate arrays, programmable logic, and/or discrete components. The hardware circuits may perform logic functions, execute computer readable programs stored on tangible storage devices, and/or execute programmed functions. Modules may also include a computer readable storage medium comprising a computer readable program stored on a tangible storage device that performs a function when executed by a hardware circuits such as a processor, microcontroller, or the like.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

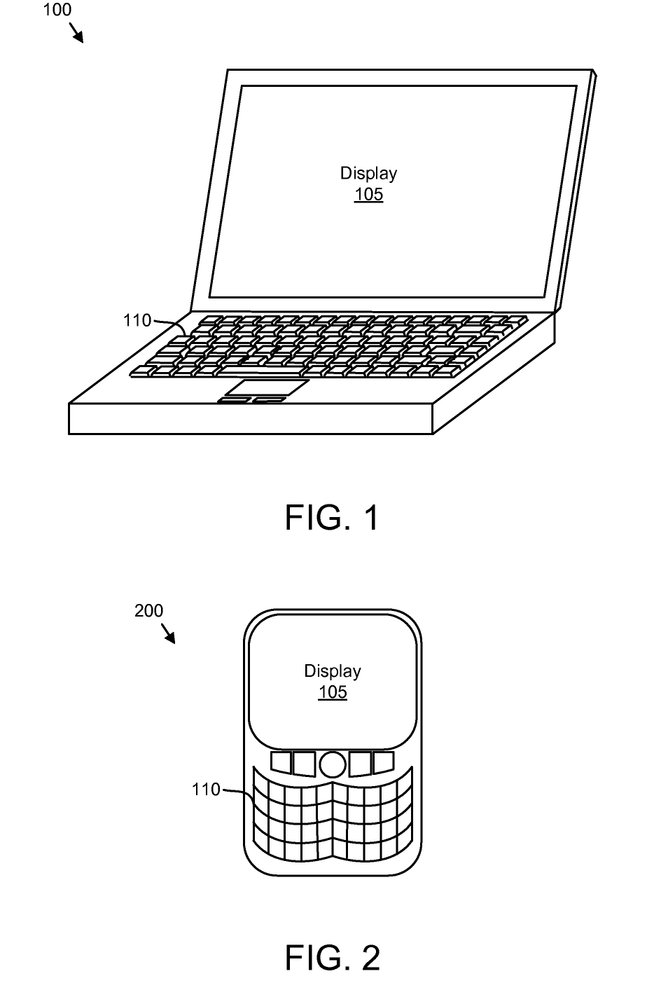

FIG. 1 is a perspective drawing illustrating one embodiment of a notebook computer 100 in accordance with the present invention. The notebook computer 100 is representative of various types of computers such as computer workstations, servers, and the like. The notebook computer 100 includes a display 105 and input devices 110 as is well known to those skilled in the art.

The notebook computer 100 is often powered by a mobile power source such as one or more battery cells. The notebook computer 100 is able to function for longer periods of time using the mobile power source if the power consumption of the notebook computer 100 is reduced. Reducing the power consumption of an electronic device such as the notebook computer 100 is also important for reducing the environmental footprint of the electronic device.

The notebook computer 100 includes a plurality of components that will be described hereafter. Each component may have one or more power statuses. For example, a component may be powered on or powered off. Alternatively, the component may have active, standby, sleep, and off mode power statuses. The component may be set to a reduced power status to reduce power consumption of the notebook computer 100.

However reducing the power consumption of the notebook computer 100 may also reduce the functionality of the notebook computer 100. The present invention automatically adjusts the power consumption of the notebook computer 100 and/or similar electronic devices while maintaining desired functionality as will be described hereafter.

FIG. 2 is a front view drawing illustrating one embodiment of a mobile phone 200 of the present invention. The phone 200 is also electronic device. As with the notebook computer 100 of FIG. 1, the phone 200 includes a display 105 and input devices 110. The power consumption of the phone 200 may also be reduced using the present invention.

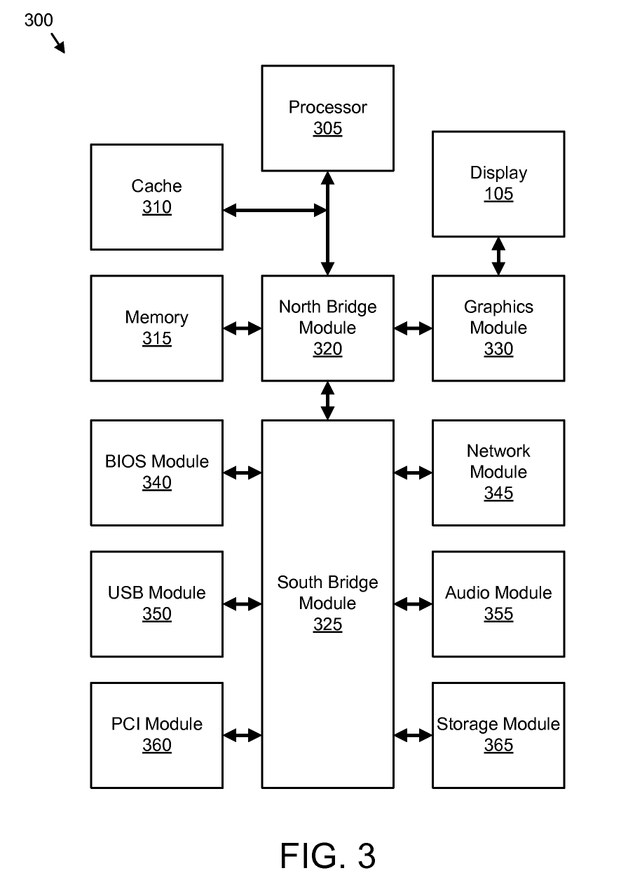

FIG. 3 is a schematic block diagram illustrating one embodiment of a computer of the present invention. The computer 300 may be embodied in the notebook computer 100 of FIG. 1. The description of the computer 300 refers to elements of FIGS. 1-2, like numbers referring to like elements. The computer 300 includes a processor 305, a cache module 310, a memory 315, a north bridge module 320, a south bridge module 325, a graphics module 330, a display 105, a basic input/output system (BIOS) module 340, a network module 345, a peripheral component interconnect (PCI) module 360, and a storage module 365.

The processor 305, cache module 310, memory 315, north bridge module 320, south bridge module 325, graphics module 330, display 105, BIOS module 340, network module 345, PCI module 360, and storage module 365, referred to herein as components, may be fabricated of semiconductor gates on one or more semiconductor substrates. Each semiconductor substrate may be packaged in one or more semiconductor devices mounted on circuit cards. Connections between the components may be through semiconductor metal layers, substrate-to-substrate wiring, circuit card traces, and/or wires connecting the semiconductor devices.

The memory 315 stores computer readable programs. The processor 305 executes the computer readable programs as is well known to those skilled in the art. The computer readable programs may be tangibly stored in the storage module 365. The storage module 365 may be a hard disk drive, an optical storage device, a holographic storage device, a micromechanical storage device, a semiconductor storage device, or the like. The power status of the storage module 365 may include an active mode, in a standby mode, in a sleep mode, or in an off mode

A processor power status may comprise a clock rate. The clock rate of the processor 305 may be adjusted to adjust the power consumption of the processor 305. In addition, the power status of the processor 305 may include the voltage of power supplied to the processor 305. For example, the power supply voltage may be reduced to reduce the power consumption of the processor 305. Thus the processor 305 may have a first power status of 2 Gigahertz (GHz) at 1.0 Volts (V) and a second power status of 1 GHz at 0.9 V.

The processor 305 may communicate with the cache module 310 through a processor interface bus to reduce the average time to access memory 315. The cache module 310 may store copies of the data from the most frequently used memory 315 locations. The computer 300 may use one or more caches 310 such as a DDR2 cache memory or the like.

The north bridge module 320 may communicate with and provide bridging functionality between the processor 305, the graphic module 330, the memory 315, and the cache 310. The processor 305 may be connected to the north bridge module 320 over a, for example, six hundred sixty seven Megahertz (667 MHz) front side bus.

A power status of the north bridge module 320, the memory 315, and the cache 310 may comprise the clock rate of the front side bus. Alternatively, the power status of the north bridge module 320, the memory 315, and the cache 310 may comprise a voltage level. The voltage level of power supply to the north bridge module 320, the memory 315, and the cache 310 may be reduced to reduce power consumption.

The north bridge module 320 may be connected to the south bridge module 325 through a direct media interface (DMI) bus. The DMI bus may provide a high-speed, bi-directional, point-to-point link supporting a clock rate for example of one Gigabytes per second (1 GBps) in each direction between the north bridge module 320 and the south bridge module 325. The south bridge module 325 may support and communicate with the BIOS module 340, the network module 345, the PCI module 360, and the storage module 365.

The PCI module 360 may communicate with the south bridge module 325 for transferring data or power to peripheral devices. The PCI module 360 may include a PCI bus for attaching the peripheral devices such as the input devices 110. The PCI bus can logically connect several peripheral devices over the same set of connections. The peripherals may be selected from a printer, a joystick, a scanner, or the like. The PCI module 360 may also be an expansion card as is well known to those skilled in the art. A power status of the PCI module 360 may include placing the PCI module 360, one or more PCI buses, and/or one or more devices connected to the PCI module 360 in an active mode, in a standby mode, in a sleep mode, or in an off mode.

The BIOS module 340 may communicate instructions through the south bridge module 325 to boot the computer 300, so that software instructions stored on the storage module 365 can load, execute, and assume control of the computer 300. Alternatively, the BIOS module 340 may comprise a coded program embedded on a chipset that recognizes and controls various devices that make up the computer 300. A power status of the BIOS module 340 may include an active mode, a standby mode, a sleep mode, or an off mode.

The network module 345 may communicate with the south bridge module 325 to allow the computer 300 to communicate with other devices over a network. The devices may include routers, bridges, computers, printers, and the like. A power status of the network module 345 may include placing the network module 345 in an active mode, in a standby mode, in a sleep mode, or in an off mode. In addition, the power status of the network module 345 may include placing devices in communication with the network module 345 in an active mode, in a standby mode, in a sleep mode, or in an off mode.

The display module 105 may communicate with the graphic module 330 to display the topological display of user interface elements as will be described hereafter. The display module 105 may be a cathode ray tube (CRT), a liquid crystal display (LCD), or the like. A power status of the display 105 may include backlighting levels for the LCD. In addition, the power status for the display 105 may include a display time interval after which power for the display 105 is reduced by reducing backlighting, displaying a screensaver, and/or powering off the display 105.

The USB module 350 may communicate with one or more USB compatible devices over a USB bus. A power status of the USB module 350 may include turning the USB module 350 and the USB bus on and turning the USB module 350 and the USB bus off. The audio module 355 may generate an audio output. A power status of the audio module 355 may include turning the audio module 355 on and turning the audio module 355 off.

In one embodiment, the south bridge module 325 includes a plurality of control registers and timers for managing power consumption for the computer 300. In one embodiment, a power status for a component such as the PCI module 360 may be implemented by writing a value to the control registers and/or to a timer for the PCI module 360.

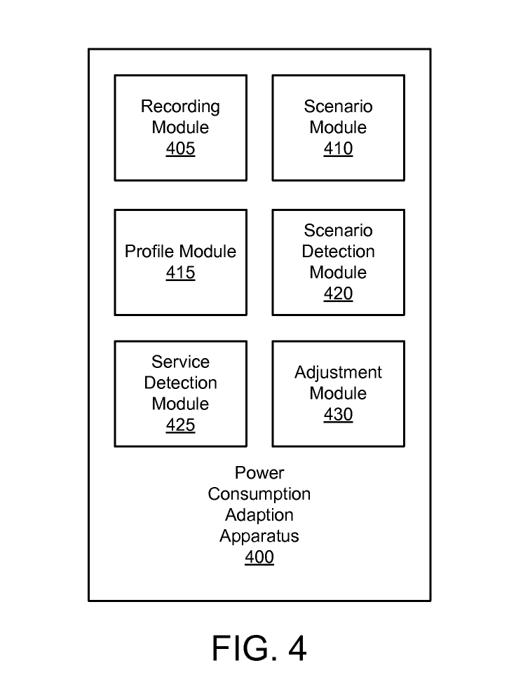

FIG. 4 is a schematic block diagram illustrating one embodiment of a power consumption adaption apparatus 400 of the present invention. The apparatus 400 may be embodied in the notebook computer 100 of FIG. 1, the mobile phone 200 of FIG. 2, and/or the computer 300 of FIG. 3. The description of the apparatus 400 refers to elements of FIGS. 1-3, like numbers referring to like elements.

The apparatus 400 includes a recording module 405, a scenario module 410, a profile module 415, a scenario detection module 420, a service detection module 425, and an adjustment module 430. In one embodiment, the recording module 405, scenario module 410, profile module 415, scenario detection module 420, service detection module 425 and adjustment module 430 each is embodied in a computer readable storage medium comprising a computer readable program stored on a tangible storage device such as the memory 315 and/or the storage module 365.

The recording module 405 records a usage record for each component within a system such as the notebook computer 100, the mobile phone 200, or the computer 300 at scheduled audit times. The usage record comprises a usage level, an application list, a time stamp, a network access point, a computation category, a time category, and a location category.

The scenario module 410 creates a plurality of usage scenarios. Each usage scenario comprises a unique combination of a specified computation category, a specified time category, and a specified location category.

The profile module 415 creates a power setting profile for each scenario. Each power setting profile specifies a target power status for each component of the system. The scenario detection module 420 detects a first usage scenario. The adjustment module 430 sets a power status of each component to the first usage scenario target power status for the component.

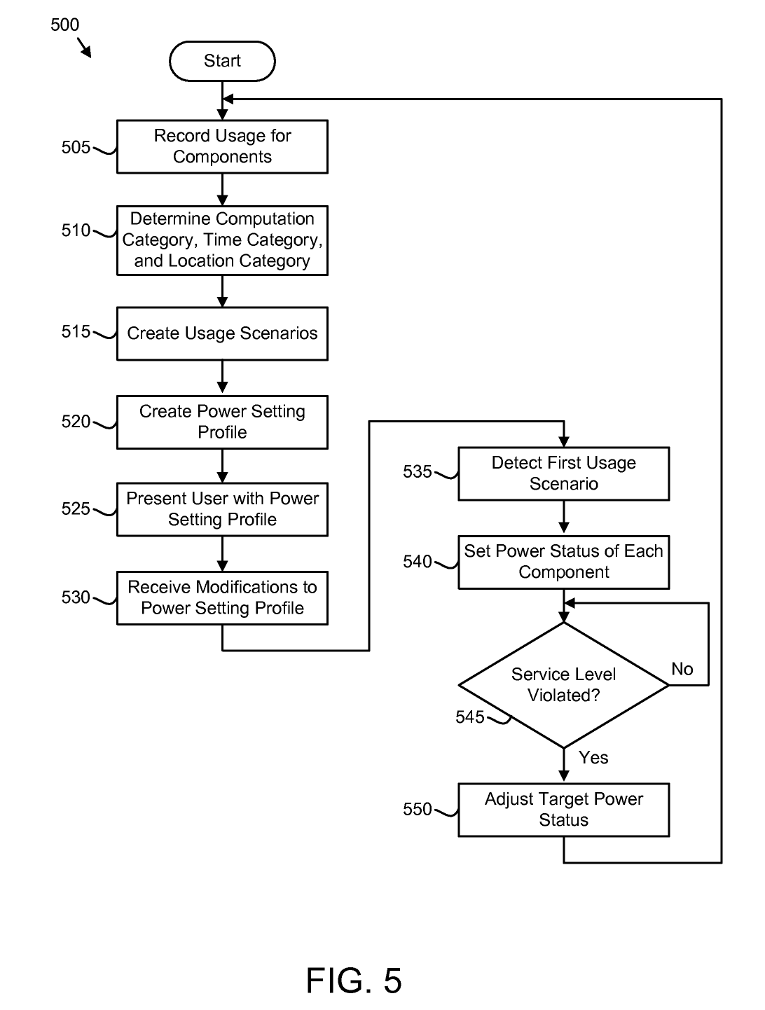

In one embodiment, the service detection module 425 detects a service level violation for a first component. The adjustment module may 430 adjust the power status for the first component to provide a specified service level. The function of the recording module 405, the scenario module 410, the profile module 415, the scenario detection module 420, the service detection module 425 and the adjustment module 430 will be described in more detail in the description of FIG. 5.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

FIG. 5 is a schematic flow chart diagram illustrating one embodiment of a power consumption adaption method 500 of the present invention. The method 500 substantially includes the steps to carry out the functions presented above with respect to the operation of the described apparatus and system of FIGS. 1-4. The description of the method 500 refers to elements of FIGS. 1-4, like numbers referring to like elements. In one embodiment, the method 500 is implemented with a computer readable storage medium comprising a computer readable program stored on a tangible storage device. The computer readable storage medium may be integrated into a computing system, such as the notebook computer 100, mobile phone 200, or computer 300, wherein the computer readable program executed by the computing system performs the method 500.

The method 500 begins, and the recording module 405 records 505 a usage record for each component within the system at scheduled audit times. For example, the recording module 405 may record 505 usage records for the processor 305, the cache 310, the memory 315, the north bridge module 320, the graphics module 330, the display 105, the south bridge module 325, the BIOS module 340, the network module 345, the USB module 350, the audio module 355, the PCI module 360, and the storage module 365. In addition, the recording module 405 may record 505 usage records for devices in communication with the system. For example, the recording module 405 may record 505 a usage record for a video camera connected to the USB module 350 over a USB bus.

The usage record may comprise a usage level, an application list, a time stamp, a network access point, a computation category, a time category, and a location category. In one embodiment, the usage level may indicate whether a component is used or not used. For example, a usage level may indicate that an optical storage device embodied in the storage module 365 is used.

In an alternate embodiment, the usage level indicates percent utilization of the component, wherein the percent utilization is in the range of 0% or no utilization to 100% or complete utilization.

In one embodiment, the application list includes all processes executed by the system. For example, the application list may include processes that are initiated by an operating system and of which a user is not aware. Alternatively, the application list may include processes that are initiated by a user. For example, if the user initiates the execution of a web browser, a word processor, and an e-mail utility, the application list may only include the web browser, the word processor, and the e-mail utility.

The time stamp may include a date and a time that a usage record is created. In addition, the time stamp may indicate whether the date is a workday or a holiday/day off for the user. In one embodiment, the time stamp indicates if the time falls within regular business hours for the user.

In one embodiment, the network access point indicates a network to which the system is connected. In addition, the network access point may specify that means for connecting to the network. For example, the network access point may record that the system is in communication with a corporate Wide Area Network (WAN) from a remote public Internet access port.

In one embodiment, the time categories comprise a business category, an extended business category, and a personal category. For example, the business category may include workdays from 8:00 a.m. to 6:00 p.m., the extended business category may include workdays from 7:00 a.m. to 8:00 a.m. and 6:00 p.m. to 8:00 p.m., and the personal category may include all other times. One of skill in art will recognize that the present invention may be practiced with other definitions for the time categories.

The computation categories may comprise a high use category and a low use category. For example, the high use category may include a sustained usage demand of the processor 305 of no more than 5% with an occasional usage demand of the processor 305 of no more than 40%. In addition, the low use category may include all usage combinations not included in the high use category. In an alternate example, the high use category may include average front side bus usage demand of 80% or more, while the low use category may include average front side bus usage demand of less than 80%.

In a certain embodiment, the location categories comprise an office category, a home category, and a remote category. The office category may include a user's home office and one or more additional facilities of the user's employer. The home category may include one or more locations where the user regularly uses the system. In addition, the remote category may include indeterminate locations such as while the user is in transit, at a hotel room, and the like.

The scheduled audit times may be a specified value such as every 15 minutes. The recording module 405 may modify the scheduled audit times. In one embodiment, the recording module 405 modifies the scheduled audit times in response to a user command. Alternatively, the recording module 405 may modify the scheduled audit times if power consumption for the system exceeds a target power consumption. For example, a system administrator may set the target power consumption for a corporation. The recording module 405 may modify the scheduled audit times if the power consumption for the system does not meet the target power consumption.

In one embodiment, the recording module 405 determines 510 the computation category, the time category, and the location category from the usage level, the application list, the time stamp, and the network access point. For example, if the application list includes an e-mail utility, a database application, and a spreadsheet, the time stamp indicates that the usage record is created on Wednesday, Oct. 22, 2008 at 10:40 a.m., and the network access point specifies that the system is connected to a corporate WAN through a secure corporate port, the recording module 405 may determine 510 that the computation category is the low use category, the time category is the business category, and the location category is the office category.

In an alternate example, if the application list includes a Digital Versatile Disk (DVD) viewing application, the time stamp indicates that the usage record is created at 8:27 p.m., and the network access point specify that the system is not connected to a network, the recording module 405 may determine 510 that the computation category is the high use category, the time category is the personal category, and the location category is the remote category.

The scenario module 410 creates 515 a plurality of usage scenarios. Each usage scenario comprises a unique combination of a specified computation category, a specified time category, and a specified location category. Table 1 illustrates usage scenarios that are prophetically exemplary for the present invention.

TABLE 1
Usage Scenarios

| | Computation | | |
|---|---|---|---|
| Usage Scenario | Category | Time Category | Location Category |
| Business 1 | High Use | Business | Office |
| Business 2 | High Use | Extended Business | Remote |
| Business 3 | Low Use | Business | Remote |
| Personal | Low Use | Personal | Home |

The profile module 415 creates 520 a power setting profile for each usage scenario. Each power setting profile specifies a target power status for each component of the system. Table 2 illustrates a prophetic power setting profile for the Business 1 usage scenario of Table 1.

TABLE 2
Power Setting Profile

| | Target |
|---|---|
| Component | Power Status |
| Processor 305 | 1 GHz, 0.9 V |
| Cache 310, Memory, 315, North Bridge | 667 MHz, 1.0 V |
| Module 320, and Front Side Bus | |
| Display 105 | Back Lit 100% |
| BIOS Module 340 | Active |
| Network Module 345 | Active |
| USB Module 350 | Standby |
| Audio Module 355 | Off |
| PCI Module 360 | Active |
| Storage Module 365 | Active |

In one embodiment, each usage scenario includes a single power setting profile. In an alternate embodiment, each scenario includes one or more power setting profiles. A primary power setting profile may be initially employed for the usage scenario. An alternative power setting profile may be employed for the usage scenario if a service level is violated.

In one embodiment, the profile module 415 sets the target power status for each component so that a specified service level is provided for the component. For example, the profile module 415 may set the target power status for the processor 305 such that a target of no more than 5% processor usage demand is satisfied 95% of the time. As used herein, service level refers to a percentage of time that the usage demand is met. In one embodiment, the specified service level was in the range of 95% to 99%.

In one embodiment, each usage scenario has a scenario service level. For example, the exemplary business 1 usage scenario may have a scenario service level of 98%. In an alternate embodiment, each component has a component service level. For example, the storage module 365 may have a component service level of 99%.

In one embodiment, the profile module 415 presents 525 the user with a power setting profile for a usage scenario. The profile module 415 may present 525 the power setting profile when the power setting profile is first created. In an alternate embodiment, the profile module 415 may present 525 the power setting profile when the power setting profile is modified. In a certain embodiment, the profile module 415 may present 525 the power setting profile each time the power setting profile is employed. The power setting profile may be displayed to the user on the display 105 of the notebook computer 100 or the display 105 of the mobile phone 200 using a graphical user interface.

The profile module 415 may further receive 530 modifications to a least one component target power status of the power setting profile for the usage scenario. The user may communicate the modifications using the input device 110 of FIGS. 1-2.

The scenario detection module 420 detects 535 a first usage scenario. In one embodiment, the scenario detection module 420 determines which computation category, time category, and location category is representative of the current system usage. In one embodiment, the current computation category, time category, and location category must match the specified computation category, specified time category, and specified location category for the first usage scenario. In an alternate embodiment, the first usage scenario is selected where the specified computation category most closely matches the current computation category, the specified time category most closely matches the current time category, and the specified location category most closely matches the current location category.

The adjustment module 430 sets 540 a power status of each component to the first usage scenario target power status for the component. For example, if the scenario detection module 420 detects 535 the exemplary business 1 usage scenario of Table 1, the adjustment module 430 may set 540 the power status of each component to the target power statuses of Table 2.

In one embodiment, the service detection module 425 detects 545 a service level violation for a first component. For example, the service detection module 425 may detect 545 usage demand for the processor 305 at 1 GHz and 0.9 V exceeds a target usage demand of 40% more.

The adjustment module 430 may adjust 550 the power status for the first component to provide the specified service level. In one embodiment, the adjustment module 430 may temporarily adjust 550 the power status for an adjustment period. The adjustment period may be in the range of 10 to 200 minutes. Alternatively, the adjustment module 430 may adjust 550 both the power status and the target power status for the power setting profile of the first usage scenario to provide the specified service level. Thereafter, the new target power status will be used. The recording module 405 continues recording 505 usage records after the adjustment module 430 adjusts 550 the power status.

The method 500 automatically creates 515 usage scenarios for the system. When a first usage scenario is detected 535, the power statuses for components in the system may be automatically set 540 to the target power statuses. Thus as a user moves from task to task, and/or location to location, the method 500 automatically adjusts power consumption to both provide an acceptable service level to the user and to reduce overall power consumption. As the user's usage habits change, the method 500 adjusts the usage scenarios and power setting profiles, continuously optimizing power usage.

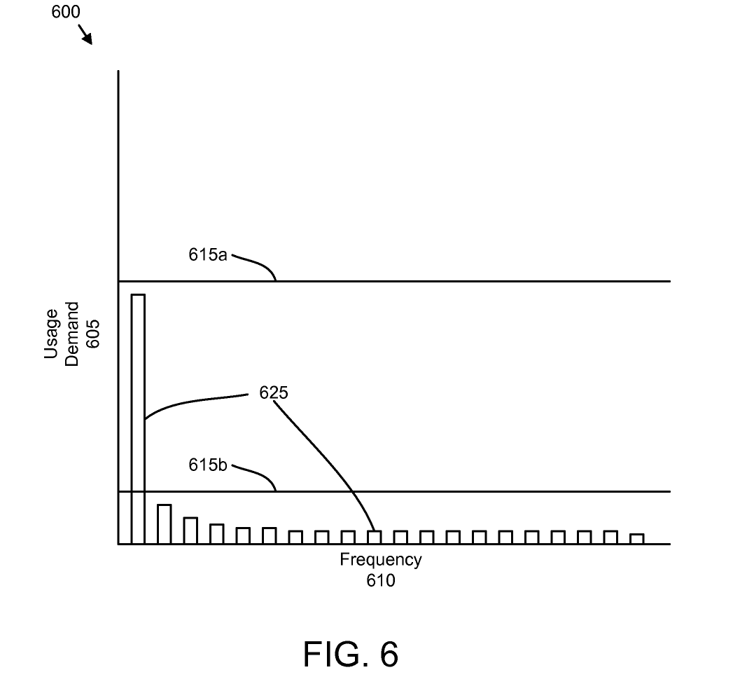

FIG. 6 is a histogram 600 illustrating a prophetic example of usage demand 605 of a component of the present invention. For example, the histogram 600 may illustrate usage demand 605 for the processor 305 of FIG. 3. The description of the histogram 600 refers to elements of FIGS. 1-5, like numbers referring to like elements. The histogram 600 may be calculated from usage records. In one embodiment, a plurality of usage records may be analyzed to generate the data represented by the histogram 600.

The histogram 600 shows average usage demand 605 at various levels 625. Each level 625 represents average usage demand occurring 5% of the time for the component. The levels 625 are arranged from most to least usage. Usage demand limits 615 are also shown. A first usage demand limit 615a represents a 40% usage demand. A second usage demand limit 615b represents 5% usage demand.

In a prophetic example, the target power status for the component may be selected such that 95% of the time the second usage demand limit 615b is satisfied and that 5% of the time the first usage demand limit 615a is satisfied. If the second usage demand limit 615b is exceeded more than 5% of the time or if the first usage demand limit 615a is exceeded, a service level may be violated.

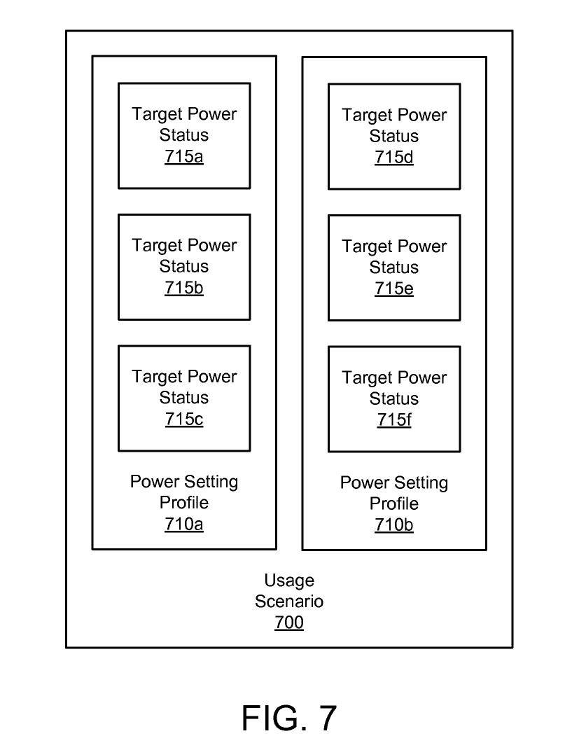

FIG. 7 is a schematic block diagram illustrating on embodiment of a usage profile 700 of the present invention. The description of usage profile 700 refers to elements of FIGS. 1-6, like numbers referring to like elements. The usage profile 700 includes one or more power setting profiles 710. Although shown with two power setting profiles 710, any number of power setting profiles 710 may be employed.

Each power setting profile 710 includes one or more target power statuses 715. In one embodiment, a target power status is included for each component. Alternatively, target power statuses are included for selected components. The usage profile 700 may be organized as a flat file, a linked array of structured data fields, and the like. In one embodiment the usage profile is stored on the storage module 365. Alternatively, the usage profile 700 may be stored in the memory 315.

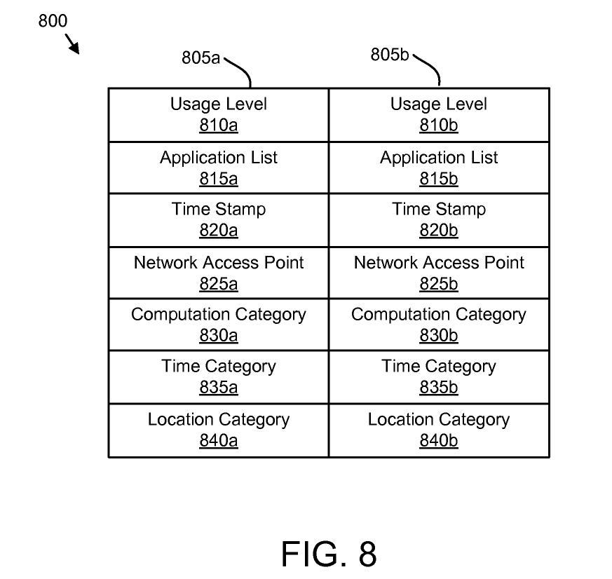

FIG. 8 is a schematic block diagram illustrating one embodiment of usage records 800 of the present invention. The description of the usage records 800 refers to elements of FIGS. 1-7, like numbers referring to like elements. The record module 405 may record 505 a plurality of usage records 805 for each component. Although for simplicity only two usage records 805 are shown, any number of usage records 805 may be employed.

In one embodiment, each usage record 805 includes the usage level 810, the application list 815, the timestamp 820, the network access point 825, the computation category 830, the time category 835, and the location category 840. Usage records 800 may be stored in a storage device 365. Alternatively, usage records 800 may be stored in a memory 315.

The present invention adapts power consumption by creating 515 usage scenarios 700, creating 520 power setting profiles 710 for the usage scenarios, detecting 535 a first usage scenario 700, and setting 540 the power status for components to target power statuses 715 for the first usage scenario 700. The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A computer readable storage medium comprising a computer readable program stored on a tangible storage device for adapting power consumption, wherein the computer readable program when executed on a computer causes the computer to:
record a usage record for components within the computer at scheduled audit times, the usage record comprising a usage level, an application, and a computation category;
create a plurality of usage scenarios, each usage scenario comprising a unique combination of a specified computation category, a specified time category, and a specified location category;
create a power setting profile for each usage scenario, each power setting profile specifying a target power status for each component of the computer;
detect a first usage scenario; and
set a power status of each component to the first usage scenario target power status for the component.

2. The computer readable storage medium of claim 1, wherein the computer readable program is further configured to cause the computer to determine the computation category, a time category, and a location category from the usage level the application, a time stamp, and a network access point.

3. The computer readable storage medium of claim 1, wherein the computer readable program is further configured to cause the computer to present a user with the power setting profile for the first usage scenario.

4. The computer readable storage medium of claim 3, wherein the computer readable program is further configured to cause the computer to receive a modification to at least one component target power status for the power setting profile of the first usage scenario.

5. The computer readable storage medium of claim 1, wherein the target power status for each component in each usage scenario is selected to provide a specified service level for the component.

6. The computer readable storage medium of claim 5, wherein the specified service level is in the range of ninety-five percent to ninety-nine percent.

7. The computer readable storage medium of claim 5, wherein the computer readable program is further configured to cause the computer to
detect a service level violation for a first component; and
adjust the power status for the first component to provide the specified service level.

8. The computer readable storage medium of claim 5, wherein each usage scenario has a scenario service level.

9. The computer readable storage medium of claim 5, wherein each component has a component service level.

10. The computer readable storage medium of claim 1, wherein the specified time category is selected from a business category, an extended business category, and a personal category.

11. The computer readable storage medium of claim 1, wherein the specified computation category is selected from a high use category and a low use category.

12. The computer readable storage medium of claim 1, wherein the specified location category is selected from an office category, a home category, and a remote category.

13. The computer readable storage medium of claim 1, wherein the computer readable program is further configured to cause the computer to modify the scheduled audit times.

14. An apparatus comprising:
a recording module recording a usage record for each component within an electronic device at scheduled audit times, the usage record comprising a usage level, an application, and a computation category;
a scenario module creating a plurality of usage scenarios, each usage scenario comprising a unique combination of a specified computation category, a specified time category, and a specified location category;
a profile module creating a power setting profile for each usage scenario, each power setting profile specifying a target power status for each component of the electronic device;
a scenario detection module detecting a first usage scenario; and
an adjustment module setting a power status of each component to the first usage scenario target power status for the component.

15. The apparatus of claim 14, the profile module further presenting a user with the power setting profile for the first usage scenario and receiving modifications to at least one component target power status of the power setting profile for the first usage scenario.

16. The apparatus of claim 14, wherein the target power status for each component in each usage scenario is selected to provide a specified service level in the range of ninety-five percent to ninety-nine percent for the component.

17. The apparatus of claim 16, further comprising a service detection module detecting a service level violation for a first component and the adjustment module adjusting the power status for the first component to provide the specified service level.

18. A system comprising:
a plurality of components, each component comprising a power status;
a memory storing computer readable programs;
a processor executing the computer readable programs, the computer readable programs comprising
a recording module recording a usage record for each component within the system at scheduled audit times, the usage record comprising a usage level, an application, and a computation category;
a scenario module creating a plurality of usage scenarios, each usage scenario comprising a unique combination of a specified computation category, a specified time category, and a specified location category;
a profile module creating a power setting profile for each usage scenario, each power setting profile specifying a target power status for each component of the system, wherein the target power status for each component in each usage scenario is selected to provide a specified service level;
a scenario detection module detecting a first usage scenario;
an adjustment module setting a power status of each component to the first usage scenario target power status for the component;
a service detection module detecting a service level violation for a first component; and
the adjustment module adjusting the power status for the first component to provide the specified service level.

19. The system of claim 18, wherein the specified service level is in the range of ninety-five percent to ninety-nine percent.

20. The system of claim 18, wherein the specified time category is selected from a business category, an extended business category, and a personal category, the specified computation category is selected from a high use category and a low use category, and the specified location category is selected from an office category, a home category, and a remote category.
